(19) United States
(12) Patent Application Publication
(10) Pub. No.: US 2009/0226188 A1
(43) Pub. Date: Sep. 10, 2009

(54) BURST-MODE AUTOMATIC GAIN CONTROL CIRCUIT

(76) Inventor: HIROKAZU KOMATSU, Tokyo (JP)

Correspondence Address: NEC CORPORATION OF AMERICA, 6535 N. STATE HWY 161, IRVING, TX, 75039, US

(21) Appl. No.: 12/398,308

(22) Filed: Mar. 5, 2009

(30) Foreign Application Priority Data
Mar. 5, 2008 (JP) JP2008-054963

(51) Int. Cl. H04B 10/06

(52) U.S. Cl. 398/202

(57) ABSTRACT

There is provided a burst-mode automatic gain control circuit capable of exerting gain control of a burst signal at high speed and stably. In the burst-mode ready digital automatic gain control circuit, by exerting control of a gain control circuit using a burst signal detecting circuit, gain control of a burst signal is exerted at high speed and stably.

### BACKGROUND OF THE INVENTION

1. Field of the Invention

The present invention relates to a burst-mode automatic gain control circuit and particularly to the burst-mode automatic gain control circuit to exert automatic gain control in an optical receiver handling a burst-mode signal.

2. Description of the Related Art

In an optical receiver handling a burst-mode signal, if high-speed response in a wider dynamic range is to be achieved by using an automatic gain control circuit, a digital automatic gain control circuit is used which discretely exerts gain switching control over an amplifier providing a plurality of fixed gains. To operate this circuit at high speed, it is necessary to judge whether or not gain is switched by using head several bits of a burst signal as much as possible.

However, the conventional technology has a problem in that, under the condition that a signal having an amplitude near to a threshold value used to judge whether or not gain switching is made is inputted (at a switching point), the gain switching operations are influenced by distortion in a peak value waveform and/or the size of signal amplitude caused by ripples of response characteristics that a receiver has and by noise components superimposed on a received signal and/or noises occurring in a receiver and, therefore, the timing for detecting a switched signal becomes unstable and a possibility of a delay in detecting time increases.

Moreover, though a pre-bias signal is inputted before the inputting of a preamble signal, in a digital control type automatic gain control circuit having a wide dynamic range, the pre-bias signal is amplified with high gain, however, noise components cause a malfunction of a gain switching detection circuit and burst signal detection circuit in some cases.

In an optical receiver handling a burst-mode signal, high-speed response in a wide dynamic range is to be realized by using an automatic gain control circuit, an automatic gain control circuit is used which exerts gain switching control, by a digital control method, over an amplifier providing a plurality of fixed gains.

In the automatic gain control circuit, the gain control timing is judged by detecting an amplitude of a burst signal so as to control gain properly according to the amplitude of the burst signal. To operate the automatic gain control circuit at high speed, it is necessary to judge whether or not gain is switched by using head several bits of the burst signal as much as possible.

However, there has been the problem that, under the condition that a signal having an amplitude neighboring a threshold value used to judge whether or not gain switching is made is inputted (at a switching point), the gain switching detection timing becomes unstable due to influences caused by distortion in a peak value waveform and/or the size of signal amplitude caused by ripples of response characteristics that a receiver has and by noise components superimposed on a received signal and/or noises occurring in a receiver and, therefore, the possibility of a delay in detecting time increases.

The method disclosed in Patent Reference 1, which has been discovered to solve these problems, is effective in prohibiting gain switching on a payload.

However, in a burst-mode optical transmitting and receiving system, to realize high-speed response of a laser diode used for a burst signal optical transmitter, a pre-bias signal activating feeble light emission is inputted before the inputting of a preamble signal in a head portion of a burst signal.

When an automatic gain control circuit providing three gain values (or more) and having a wide dynamic range is used, an amplitude of the pre-bias signal causing feeble light emission reaches a threshold for judging the gain switching in some cases. At this time point, gain switching control is started by the rising of a pre-bias signal, however, since a preamble signal having an amplitude being larger than that of the pre-bias signal is inputted after the inputting of the pre-bias signal and, therefore, it is necessary to perform the gain setting (switching) properly corresponding to the amplitude of the preamble signal.

The Patent Reference 1 discloses configurations for prohibiting gain switching by using a data detecting comparator and a delay circuit.

However, the conventional technology disclosed in the Patent Reference 1 presents the following problems.

That is, in the Patent Reference 1, the circuit configuration is disclosed in which the gain switching is prohibited using the data detecting comparator and a delay circuit and, by using the delay circuit, a pre-bias signal is masked, thus enabling the gain switching after the inputting of the pre-bias signal, however, in the case where an amplitude of the pre-bias signal is small and does not reach the threshold voltage, due to the use of the delay circuit, detection time is made long, which disables high-speed gain switching operations in a wide dynamic range.

### SUMMARY OF THE INVENTION

In view of the above, it is an object of the present invention to provide a burst-mode automatic gain control circuit capable of exerting control of a gain of a burst signal at high speed and stably.

According to a first aspect of the present invention, there is provided a bust-mode ready digital automatic gain control circuit which can exert control of a gain of a burst signal by controlling operations of a gain control circuit using a burst signal detection circuit.

According to a second aspect of the present invention, there is provided a burst-mode ready digital automatic gain control circuit including a burst signal detection circuit capable of stopping operations of a switch detecting circuit in head several bits of a burst signal in order to detect a gain switching operation at high speed and stably.

In the burst-mode ready digital automatic gain control circuit, the detection of a burst signal is achieved by a counter made up of cascade-connected rising edge detecting circuits and a preamble signal “1010 . . . ” is detected.

In the burst-mode ready digital automatic gain control circuit, the gain switching operation is not stopped during a pre-bias signal section being inputted before the inputting of the preamble signal and the gain switching operation can be stably performed in head several bits of the preamble signal and high-speed gain switching operations become possible in a wide dynamic range.

With the above configurations, there can be provided the burst-mode automatic gain control circuit capable of exerting gain control of a burst signal at high speed and stably.

Since the gain switching is completed by using several bits of a preamble signal, high speed response becomes possible where the consumption of the number of preamble bits can be reduced.

An effect of being not easily influenced by a length of the preamble signal or its presence or absence is achieved.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing configurations of a burst-mode automatic gain control circuit according to embodiments of the present invention;

FIG. 2 is a diagram showing one example of a concrete configuration of each of the components shown in FIG. 1;

FIG. 3 is a timing chart used to explain operations of the circuit of a first embodiment shown in FIG. 2;

FIG. 4 is a timing chart used to explain operations of the circuit of the first embodiment shown in FIG. 2;

FIG. 5 is a timing chart used to explain operations of the circuit of the first embodiment shown in FIG. 2;

FIG. 6 is a diagram showing concrete configurations of the circuit of a second embodiment of the present invention;

FIG. 7 is a timing chart used to explain operations of the circuit of the second embodiment of the present invention shown in FIG. 6;

FIG. 8 is a timing chart used to explain operations of the circuit of the second embodiment of the present invention shown in FIG. 6;

FIG. 9 is a timing chart used to explain operations of the circuit of the second embodiment of the present invention shown in FIG. 6;

FIG. 10 is a diagram showing concrete configurations of the circuit of a third embodiment of the present invention;

FIG. 11 is a timing chart used to explain operations of the circuit of a third embodiment shown in FIG. 10.

FIG. 12 is a diagram showing concrete configurations of the circuit of a fourth embodiment shown in FIG. 10;

FIG. 13 is a diagram showing concrete configurations of the circuit of a fifth embodiment of the present invention;

FIG. 14 is a timing chart used to explain operations of the circuit of the fifth embodiment shown in FIG. 13.

FIG. 15 is a diagram showing concrete configurations of the circuit of a sixth embodiment of the present invention; and

FIG. 16 is a timing chart used to explain operations of the circuit of the sixth embodiment shown in FIG. 15.

### DETAILED DESCRIPTION OF THE PREFERRED EMBODIMENTS

Best modes of carrying out the present invention will be described in further detail using various embodiments with reference to the accompanying drawings.

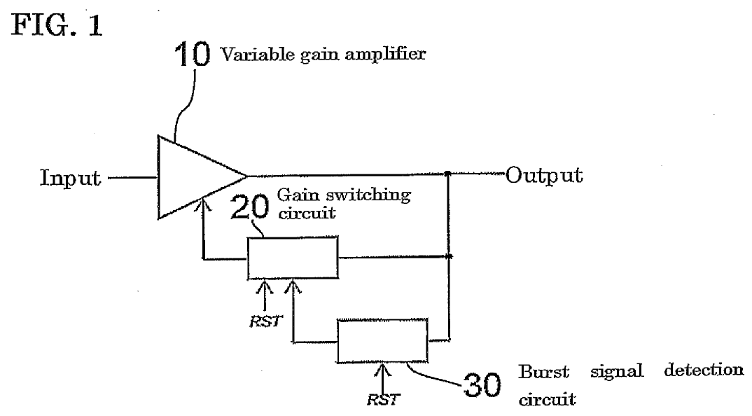

FIG. 1 is a block diagram showing configurations of a burst-mode automatic gain control circuit of one embodiment of the present invention.

As shown in FIG. 1, the burst-mode automatic gain control circuit includes a variable gain amplifier 10, a gain switching circuit 20, and a burst signal detection circuit 30.

The variable gain amplifier 10 amplifies an input signal according to a value preset in the gain switching circuit 20 and outputs the amplified signal.

The gain switching circuit 20 is a switch judging circuit used to compare an amplitude of a signal outputted from the variable gain amplifier 10 with a threshold voltage preset for judging whether or not a gain is switched and, when an amplitude of the amplified signal outputted from the variable gain amplifier 10 exceeds the threshold voltage preset for judging the gain switching, determines that the gain has been switched and outputs the signal to the variable gain amplifier 10.

The burst signal detection circuit 30 detects a burst signal identifying signal (preamble signal) “1010 . . . ” outputted from the variable gain amplifier 10 by using a comparator in which a threshold voltage being lower than the threshold for judging the gain switching is preset and then controls operations of the gain switching circuit 20 based on the detected burst signal identifying signal.

### Embodiment 1

Operations of the circuit of the first embodiment of the present invention are described by referring to FIGS. 1 to 5.

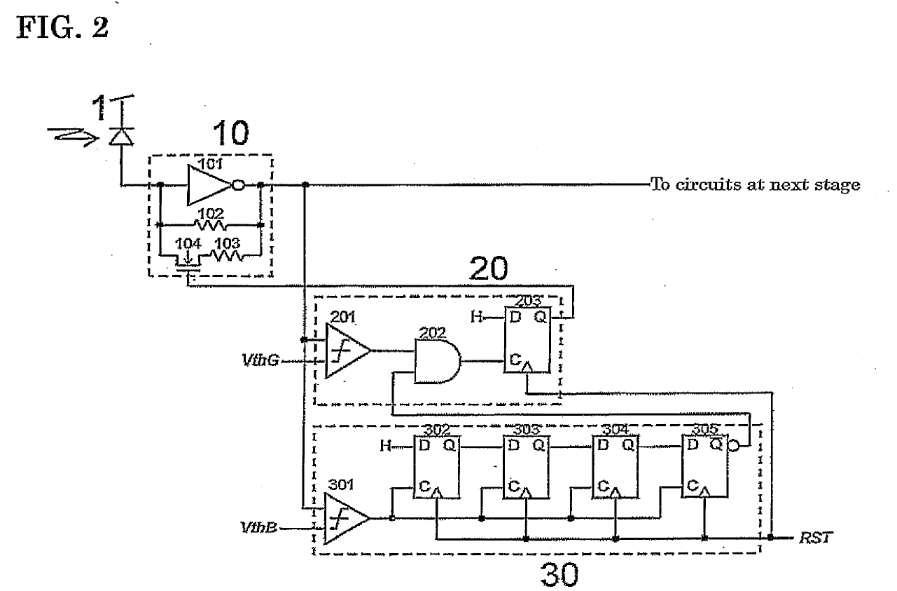

FIG. 2 is a diagram showing one example of a concrete configuration of each of the components shown in FIG. 1.

The variable gain amplifier 10 shown in FIG. 1 has, for example, the configurations shown in FIG. 2.

As shown in FIG. 2, the variable gain amplifier 10 is made up of an inverting amplifier 101, a first resistor 102, a second resistor 103, and an N-channel MOS (Metal Oxide Semiconductor) transistor, and an output from the gain switching circuit 20 is connected to a gate terminal of the N-channel MOS transistor.

When a control signal of the gain switching circuit 20 is in a LOW state, the N-channel MOS transistor 104 gets into an OFF state, not participating in the operations of the amplifier. At this time point, if a current signal is inputted to an input terminal of the gain switching circuit 20, the current is converted into a voltage by the first resistor 102 connected in parallel to the inverting amplifier 101, as a result, outputting a high gain voltage.

If the control signal of the gain switching circuit 20 is in a HIGH state, the N-channel MOS transistor 104 gets into an ON state and, when a current signal is inputted to an input terminal of the gain switching circuit 20, a current flows through the second resistor 103 via the first resistor 102 and the N-channel MOS transistor 104 connected in parallel to the inverting amplifier 101. As a result, the current is converted into a voltage by the combined resistance of the first resistor 102 and the second resistor 103, as a result, outputting a low gain voltage. Thus, the variable gain amplifier 10 serves as a variable amplifier providing two gain values.

The gain switching circuit 20 has, for example, the configuration shown in FIG. 2.

As shown in FIG. 2, the gain switching circuit 20 is made up of a comparator 201 connected to an output of the variable gain amplifier 10, an AND gate circuit 202 to which an output from the comparator 201 and an output from the burst signal detection circuit 30 are inputted, and a latching circuit 203 to which an output from the AND gate circuit 202 and a reset signal are inputted.

When a signal having an amplitude exceeding a threshold voltage VthG is inputted to the comparator 201, a gain switching signal is outputted in a manner to lower a gain of the variable gain amplifier 10.

While the burst signal detection circuit 30 is detecting a head of a burst signal (that is, while its output is high), both inputs to the AND gate circuit 202 are in a HIGH state and, therefore, the same signal as the output from the comparator 201 is outputted. This signal, when inputted to the latching circuit 203, makes a low-to-high transition and, at the same time, the state is held and a constant gain switching signal continues to be outputted until next resetting of a burst signal occurs.

If it is judged that the burst signal detection circuit 30 has completed the detection of the burst signal head, one of the inputs to the AND gate circuit 30 becomes low and, therefore, even when an output from the comparator 201 is switched from a low to a high, the output from the AND gate circuit 30 remains low and the transition to the output state of the latching circuit 203 does not occur and no switching is performed until next resetting of a burst signal occurs.

The burst signal detecting circuit 30 has, for example, the configuration shown in FIG. 2.

As shown in FIG. 2, the burst signal detection circuit 30 is made up of a comparator 301 connected to an output from the variable gain amplifier 10 and a counter in which latching circuits 302 to 305 connected to an output from the comparator 301 are cascade-connected and an output from the latching circuit 305 for producing inverted outputs is used as an output from the burst signal detection circuit 30.

A threshold voltage VthB of the comparator 301 is preset to be a value being lower than the threshold voltage VthG of the comparator 201. Before a burst signal is inputted to the latching circuits, resetting occurs in each of the latching circuits and an output from each of the latching circuits 302 to 304 is set to be a low and an output from the latching circuit 305 is set to be a high.

Next, when a signal having an amplitude exceeding the gain switching threshold voltage VthG is inputted to the comparator 201, the signal amplitude exceeds the burst signal detecting threshold voltage VthB preset to the comparator 301 and, when an amplitude of a head pulse of a burst signal exceeds the burst signal detecting threshold voltage VthB, at the same time with the signal switching (that is, signal rising), an output from the latching circuit 302 is switched from a low to a high.

Then, at the same time with rising of a second pulse and third pulse of the burst signal, outputs from the latching circuits 303 and 304 are sequentially switched from a low to a high and, at the same time with rising of a fourth pulse, an output from the latching circuit 305 is switched from a high to a low and finally, at the time of rising of the fourth pulse of the burst signal, an output from the burst signal detection circuit 30 becomes low, whereby the detection of the burst signal is completed.

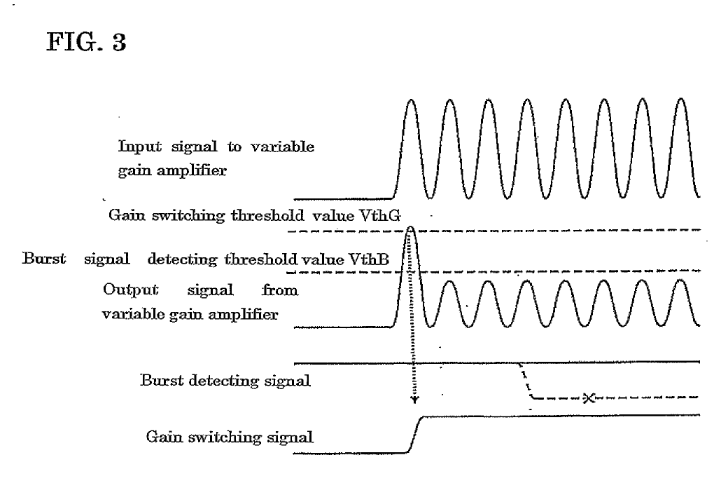

FIGS. 3 to 5 are timing charts used to explain operations of the circuit in the first embodiment shown in FIG. 2, showing operation timing of an input signal to the variable gain amplifier 10 and an output signal from the variable gain amplifier 10, an output signal from the burst signal detection circuit 30, and an output signal from the gain switching circuit 20.

FIGS. 3 to 5 show that waveforms of the input signals to the variable gain amplifier 10 are slightly different from one another.

FIG. 3 shows the normal case where a response of an inputted burst signal is good and pulse peak values are uniform from a head pulse onwards, and a signal having an amplitude slightly exceeding the gain switching threshold voltage VthG is inputted.

The amplitude of a first pulse of the input signal exceeds the gain switching threshold voltage VthG and, therefore, the gain switching circuit 20 outputs a gain switching signal at the time of occurrence of the first pulse of the input signal. As a result, a gain of the variable gain amplifier 10 is lowered and an output signal amplitude of a second pulse onwards from the variable gain amplifier 10 is reduced, thereafter causing its low-gain fixed operations. At this time point, the amplitude of the first pulse of the output signal from the variable gain amplifier 10 exceeds the burst signal detecting threshold voltage VthB and does not exceed the threshold voltage thereafter and, as a result, the output signal remains high, thus making no state transition.

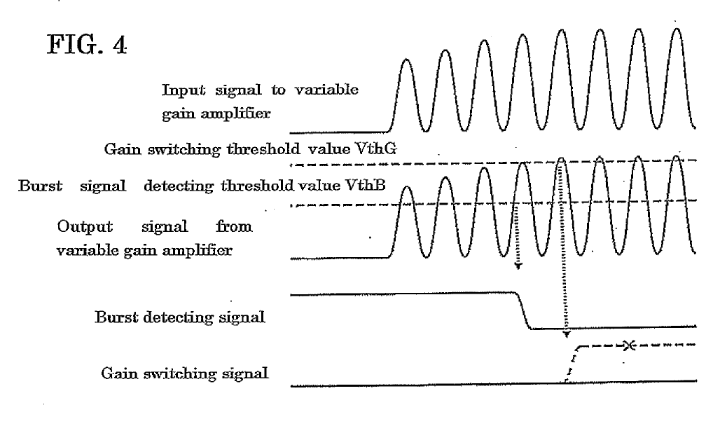

FIG. 4 shows the case where a peak voltage of the burst input signal slightly increases with the lapse of time. The timing chart shown in FIG. 4 contemplates the case where a burst-mode response characteristic is bad due to influences caused by a transmitter or a receiver connected oppositely to the burst-mode optical receiver. In this case, the amplitude of the input signal becomes approximately equivalent to the peak value shown in FIG. 3 from the fifth pulse onwards and their peak value gradually becomes high from the first pulse.

In the above case, the amplitude of an output signal from the variable gain amplifier 10 exceeds the gain switching threshold voltage VthG at the time of the occurrence of the fifth pulse of the input signal. At the same time, the amplitude of the output signal from the variable gain amplifier 10 exceeds the burst signal detecting threshold voltage VthB preset to be lower than the gain switching threshold voltage VthG in the first head pulse onwards and, therefore, the output from the burst signal detection circuit 30 is switched from a high to a low at the time of occurrence of the fourth pulse. As a result, the output from the gain switching circuit 20 remains low without making any transition and the state is held by the inputting of a next reset signal and the variable gain amplifier 10 operates while still providing a high gain.

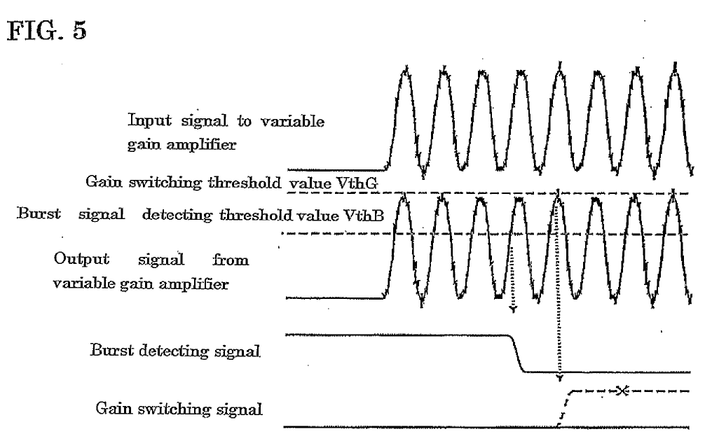

FIG. 5 shows the case where a noise is superimposed on an input signal and operations during practical use are contemplated.

In this case, a signal having an amplitude of the noise signal exceeding the gain switching threshold voltage VthG is superimposed on a peak of a fifth pulse of the input signal. The operations at this time are the same as those shown in FIG. 4 and the variable gain amplifier 10 operates while still providing high gain.

As is explained in the cases shown in FIGS. 3 to 5, the circuit of the embodiment of the present invention completes the judgment as to whether or not gain is to be switched by the fourth pulse to achieve high-speed switching operations.

### Embodiment 2

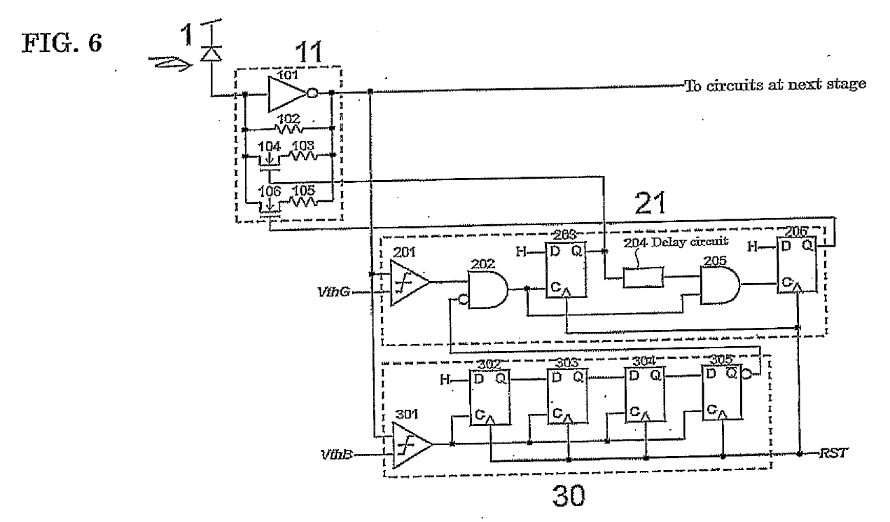

Operations of the circuit of the second embodiment of the present invention are described by referring to FIGS. 6 to 9.

Unlike the first embodiment in which the gain control circuit provides two gain values, in the second embodiment, the gain control circuit provides three gain values, which enables its use for an optical receiver having a wider dynamic range.

The variable gain amplifier 11 has, for example, configurations shown in FIG. 6.

As shown in FIG. 6, the variable gain amplifier 11 is made up of an inverting amplifier 101, a first resistor 102, a second resistor 103, and a first N-channel MOS transistor 104, in which a first output of a gain switching circuit 21 is connected to a gate terminal of the first N-channel MOS transistor 104. Moreover, a third resistor 105 and a second N-channel MOS transistor 106 are connected in parallel to the inverting amplifier 101 and a gate terminal of the second N-channel MOS transistor 106 is connected to a second output from the gain switching circuit 21.

When both first and second output signals of the gain switching circuit 21 are in a LOW state, a first and second N-channel MOS transistors 104 and 106 get into an OFF state and do not participate in operations of the amplifier. Therefore, if a current signal is inputted to an input terminal of the variable gain amplifier 11, the inputted current is converted into a voltage by the first resistor 102 connected in parallel to the inverting amplifier 101 to output a high gain voltage.

When the first output signal of the gain switching circuit 21 is high and its second output signal is low, the first N-channel MOS transistor 104 gets into an ON state and the second N-channel MOS transistor 106 gets into an OFF state and a current signal is inputted to the input terminal of the gain switching circuit 21, the current flows through the second resistor 103 via the first resistor 102 and first N-channel MOS transistor 104 connected in parallel to the inverting amplifier 101. As a result, the current is converted into a voltage by the combined resistance of the first resistor 102 and the second resistor 103, whereby an intermediate gain voltage is outputted.

Next, when both the first and second output signals of the gain switching circuit 21 are high, both the first and second N-channel MOS transistors get into an ON state and, if a current signal is inputted to the input terminal of the gain switching circuit 21, the current flows through the third resistor 105 via the first resistor 102 and the first N-channel MOS transistor 104 connected in parallel to the inverting amplifier 101 and via the second resistor 103 and second N-channel MOS transistor 106. Therefore, the current is converted into a voltage by a combined resistance of the first resistor 102, second resistor 103 and third resistor 105, whereby a low gain voltage is outputted. Thus, the variable gain amplifier 11 serves as a variable gain amplifier providing three gain values.

The gain switching circuit 21 has, for example, configurations shown in FIG. 6.

As shown in FIG. 6, the gain switching circuit 21 includes a comparator 201 connected to an output of the variable gain amplifier 11, a first AND gate circuit 202 to which an output from the comparator 201 and an output from the burst signal detection circuit 30 are inputted, and a first latching circuit 203 to which an output from the AND gate circuit 202 and a reset signal are inputted.

Further, the gain switching circuit 21 includes a delay circuit 204 connected to an output of the first latching circuit 203, a second AND gate circuit 205, to which an output from the first AND gate circuit 202 is inputted, connected to an output from the delay circuit 204, and a second latching circuit 206 to which an output from the second AND circuit 205 and a reset signal are inputted, in which an output from the first latching circuit 230 is used as a first output and an output from the second latching circuit 206 is used as a second output.

When a signal having an amplitude exceeding the threshold voltage VthG is inputted to the comparator 201, a high signal is outputted from the comparator 201 and, if the burst signal detection circuit 30 detects a head of a burst signal at the same time and is outputting a high signal, inputs to the first AND gate circuit 202 are in the same state as for the comparator 201 and the same output as in the comparator 201 is produced.

The first latching circuit 203, at the same time when an output from the first AND gate circuit 202 is switched from a low to a high, gets into a HIGH state and continues to hold the state until next resetting of a burst signal occurs. Then, a gain switching signal is outputted to the first output port and, at the next moment, the variable gain amplifier 11 begins to operate with an intermediate gain. In the state where the variable gain amplifier 11 is operating with intermediate gain, when a next pulse is inputted to the variable gain amplifier 11 and if an amplitude of the output from the variable gain amplifier 11 exceeds the threshold voltage VthG preset to the comparator 210 and the burst signal detection circuit 30 outputs a high signal, a high signal is outputted from the first AND gate circuit 202.

The second latching circuit 206, when an output from the second AND gate circuit 205 and the signal outputted from the first latching circuit 203 through the delay circuit 204 become high simultaneously, gets into a HIGH state at the same time with the signal switching and continues to hold the state until next resetting occurs. To the second output port is outputted the second gain switching signal and the variable gain amplifier 11 gets into the state of operations with a low gain.

Thus, the gain switching circuit 21 of the embodiment operates so as to judge, by using a head pulse of an input signal, whether or not a high gain operation is to be determined and, after receiving a next signal in the intermediate gain operation following the judgment of the gain switching, to sequentially make judgment as to whether or not the intermediate gain operation is to be determined.

The burst signal detection circuit 30 has, for example, configurations shown in FIG. 6 and can be implemented by the configurations similar to those shown in FIG. 2.

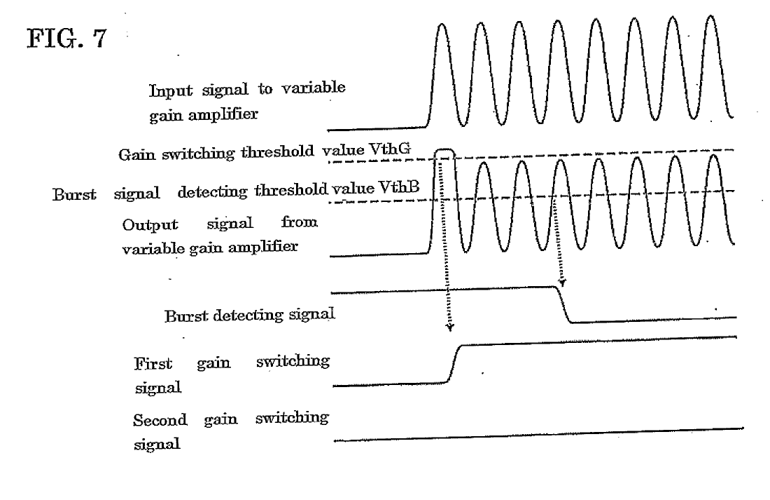

FIGS. 7 to 9 are timing charts used to explain operations of the circuit in the second embodiment shown in FIG. 6 in which an input signal and output signal to and from the variable gain amplifier 11 shown in FIG. 6, an output signal from the burst signal detection circuit 30 and an output signal from the gain switching circuit 21 are shown.

In FIGS. 7 to 9, waveforms of the input signals to the variable gain amplifier 11 are slightly different from one another.

FIG. 7 shows the case where the variable gain amplifier 11 continues to operate with intermediate gain and a signal having an amplitude slightly not exceeding the gain switching threshold voltage VthG is inputted therein.

Since the amplitude of a first pulse of an input signal exceeds the gain switching voltage VthG, a first gain switching signal from the gain switching circuit 21 makes a transition from a low to a high at the time of occurrence of the first pulse of the input signal and gain provided by the variable gain amplifier 11 is lowered to intermediate gain level. As a result, the amplitude of the output signal from the variable gain amplifier 11 begins to decrease in the second pulse onwards, however, since the amplitude of the output signal exceeds the burst signal detecting threshold voltage, an output from the signal detecting circuit 30 becomes high at the same time with the rising of a fourth pulse and the switching of gain to a low level is disabled. Therefore, in a fifth pulse onwards, even if the amplitude of the output signal from the variable gain amplifier 11 exceeds the gain switching threshold voltage VthG due to noises, pattern effects, and the like, the variable gain amplifier 11 continues to operate with intermediate gain in a stable state.

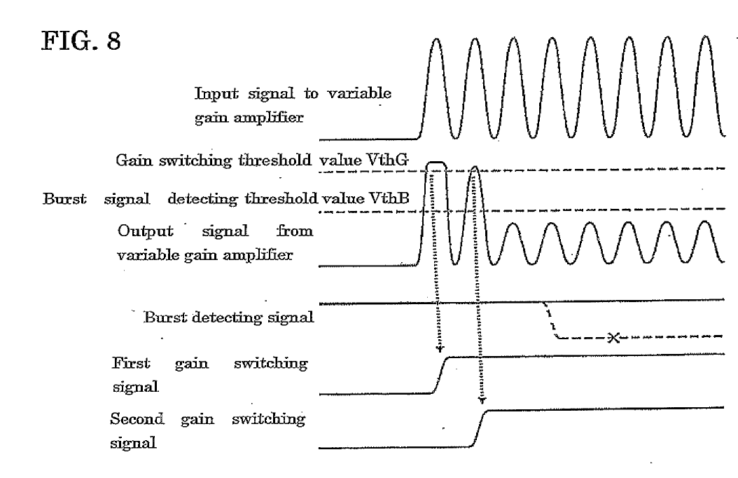

FIG. 8 shows the case where a gain provided by the variable gain amplifier 11 is switched so that the amplifier 11 operates with low gain. An amplitude of a first pulse of an input signal exceeds the gain switching threshold VthG and the first gain switching signal from the gain switching circuit 21 becomes high at the time of occurrence of a first pulse and the gain provided by the variable gain amplitude 11 is switched so that the amplifier 11 operates with intermediate gain and, though the amplitude of an output signal from the variable gain amplifier 11 is decreased, since an amplitude of a next second pulse exceeds the gain switching threshold voltage VthG, the second gain switching signal becomes high and gain is switched to a lower level so that the amplifier 11 operates with low gain in a stable state.

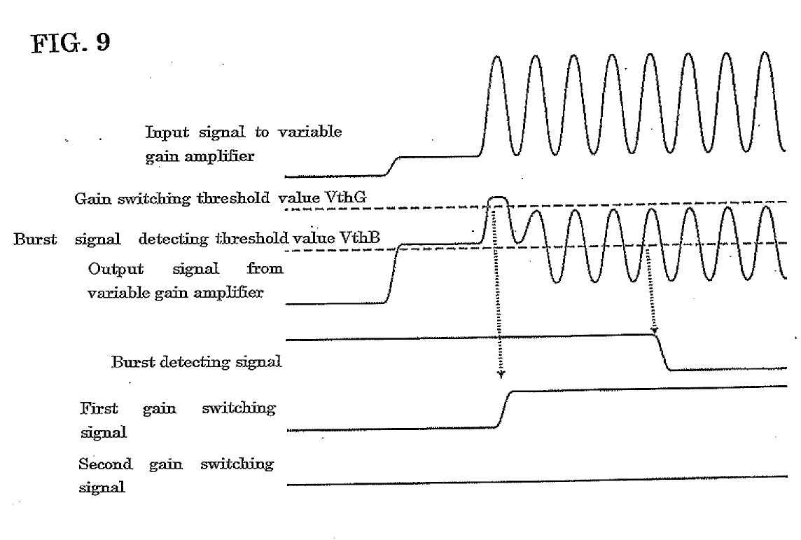

FIG. 9 shows the case where, in order to cause a laser diode used in the burst-mode optical transmitter to respond at high speed, a pre-bias signal to cause feeble light emission is inputted just before the inputting of a preamble signal and where the amplitude of the pre-bias signal slightly exceeds the burst signal detecting threshold voltage while the variable gain amplifier 11 operates with high gain and, after the gain switching operation, as in the case of FIG. 7, the variable gain amplifier 11 is allowed to constantly operate with intermediate gain and a signal whose amplitude does not slightly exceed the gain switching threshold voltage VthG is inputted.

At this time, as in the case of FIG. 7, the amplitude of the first pulse of the input signal exceeds the gain switching threshold voltage VthG and, therefore, the first gain switching signal from the gain switching circuit 21 makes a transition from a low to a high and the gain provided by the variable gain amplifier 11 is decreased to its intermediate level and the amplitude of the output signal from the variable gain amplifier 11 is reduced at the time of occurrence of the second pulse.

On the other hand, the burst signal detection circuit 30 starts a detecting operation during the pre-bias section since the amplitude of the pre-bias signal, at the time of its rising, exceeds the burst signal detecting threshold voltage VthB.

In this case, as shown in FIG. 9, at the time of the rising of the fifth pulse of the input signal, the amplitude of the pre-bias single exceeds the burst signal detecting threshold voltage VthB fourth time and, therefore, at this time point, an output signal from the burst signal detection circuit 30 makes a transition from a high to a low, whereby the gain switching is disabled thereafter.

The circuit of the embodiment of the present invention is capable of detecting a pulse signal and of completing a gain switching operation using several head bits of the pulse signal and, therefore, of achieving the high-speed gain switching operation without being dependent on a length of a pre-bias signal.

That is, according to the circuit of the present invention, by using several bits of the preamble signal, the gain switching operation can be completed, which enables a high-speed response with a small number of preamble bits being consumed.

Moreover, the circuit of the present invention provides an effect of being not easily influenced by the length of a preamble signal or by absence or presence of the preamble signal.

### Embodiment 3

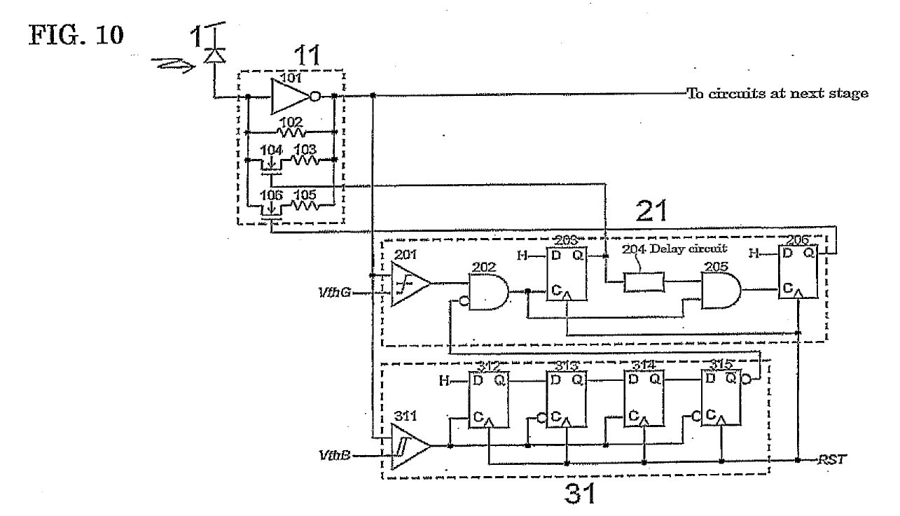

FIG. 10 shows the case where the burst signal detection circuit of the second embodiment shown in FIG. 6 is modified. The burst signal detection circuit 31 is one of the modifications.

As shown in FIG. 10, the burst signal detection circuit 32 of the third embodiment includes a comparator 311 connected to an output from a variable gain amplifier 11 and a counter connected to the output from the comparator 311, which is made up of latching circuits 312 to 315 being cascade-connected thereto and an output from the latching circuit 315 for producing inverted outputs is used as an output from the burst signal detection circuit 31. The burst signal detection circuit of FIG. 10 differs from that of FIG. 6 in that the comparator 311 has a hysteresis width ΔVh and in that, when the comparator 311 is connected to each of the latching circuits 313 to 315, the polarity is reversed.

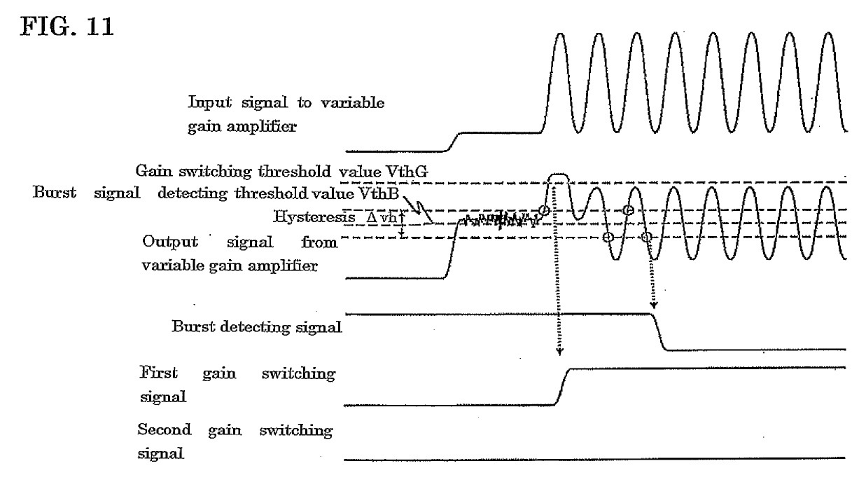

FIG. 11 shows the timing chart showing operations of the circuit shown in FIG. 10 under conditions including the inputting of the preamble signal, which corresponds to the operations shown in FIG. 9.

Configurations other than those of the burst signal detection circuit 31 are the same as those shown in FIG. 6 and, therefore, differences in operations between the burst signal detection circuit 31 shown in FIG. 11 and that shown in FIG. 6 are described.

By the hysteresis of the hysteresis comparator 311 in the burst signal detection circuit 31, the voltage at which an output from the hysteresis comparator 311 becomes high is a burst signal detecting threshold voltage VthB+ΔVh/2 and, as a result, the output signal does not become high until a first pulse of the input signal rises and the output from the latching circuit 312 remains high.

Next, the voltage at which an output from the hysteresis comparator 311 is switched from a high to a low is a burst signal detecting threshold voltage VthB−ΔVh/2 and, as a result, the output signal becomes low at the time of fall in the second pulse. The output signal from the hysteresis comparator 311 and the input signal to the latching circuit 313 are logically inverted and connected to each other and, therefore, an output from the latching circuit 313 is switched from a low to a high.

Further, at the time of the rising of the third pulse, an output from the latching circuit 314 is switched from a low to a high and, at the time of the falling of the third pulse, an (inverted) output from the latching circuit 315 is switched from a high to a low.

By letting the comparator have hysteresis, which is one of features of the circuit of the present invention, even when noises are superimposed on the pre-bias signal as shown in FIG. 11, a malfunction caused by chattering can be prevented. Thus, according to the third embodiment, high-speed switching operations in the third pulse can be reliably performed.

Further, as in the cases in FIG. 2 and FIG. 6, the timing of completing switching operations can be easily changed by increasing or decreasing the number of stages of the counter.

### Embodiment 4

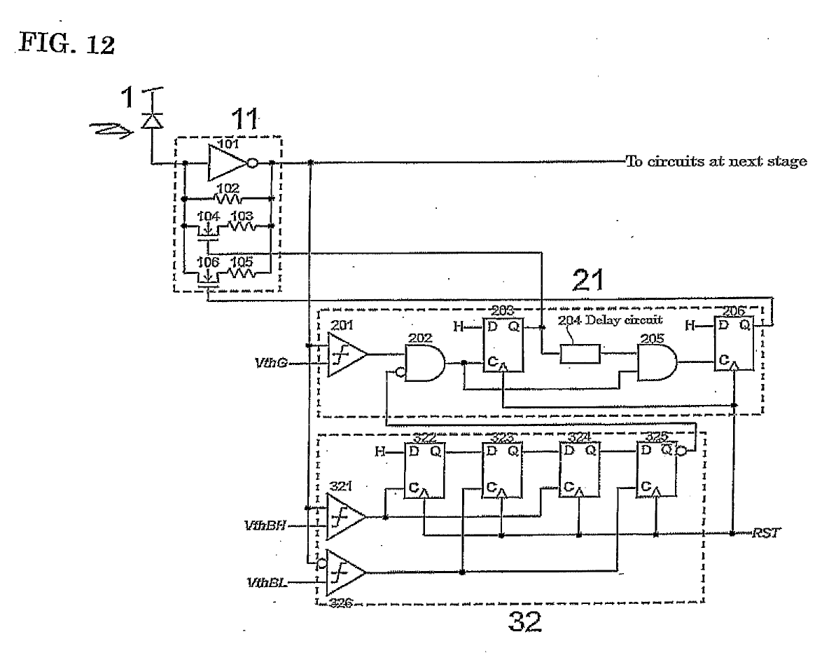

FIG. 12 shows the case where the burst signal detection circuit of the second embodiment shown in FIG. 6 is modified. The burst signal detection circuit 32 is one of the modifications.

As shown in FIG. 12, the burst signal detection circuit 32 includes a first comparator 321 connected to an output of the variable gain amplifier 11 and a counter made up of latching circuits 322 and 324, which are cascade-connected to each other, connected to an output from the first comparator 321 and a second comparator connected, in a logically inverted manner, to an output of the variable gain amplifier 11 and a counter made up of latching circuits 323 and 325, which are cascade-connected to each other, connected to an output from the second comparator 321 and an output from the latching circuit 325 producing the inverted output is used as an output from the burst signal detection circuit 32.

The burst signal detection circuit 32 of FIG. 12 differs from that of FIG. 6 in that two comparators each having a different threshold voltage are used and the counter circuits are employed in which an output from each of the comparators is used as an input to each of the counter circuits. Moreover, signals are inverted-inputted to the second comparator 326 and, therefore, the counters are made operable by a transition of an output from the variable gain amplifier 11 from a high to a low.

Operations of the burst signal detection circuit 32 of the fourth embodiment are almost the same as those of the circuit of the third embodiment shown in FIG. 10. As described above, in the embodiment, two comparators for detection are used. That is, in the first comparator 321, instead of the threshold voltage VthB+ΔVh/2 at which a signal is switched from a low to a high applied when the hysteresis comparator 311 is used, a first burst signal detecting threshold voltage is used and, in the second comparator 326, instead of the threshold voltage VthB−ΔVh/2 at which a signal is switched from a high to a low applied when the hysteresis comparator 311 is used, a second burst signal detecting threshold voltage is used. As in the case of FIG. 10, even when noises are superimposed on the pre-bias signal, a malfunction caused by chattering can be prevented.

The advantage of configuring the burst signal detection circuit 32 by using two comparators instead of using the hysteresis comparator having a positive feedback circuit is that the circuit can be realized by simpler circuit configurations and its operations can be high-speed and the setting of threshold voltages is easy when compared with the case of using the hysteresis comparator.

### Embodiment 5

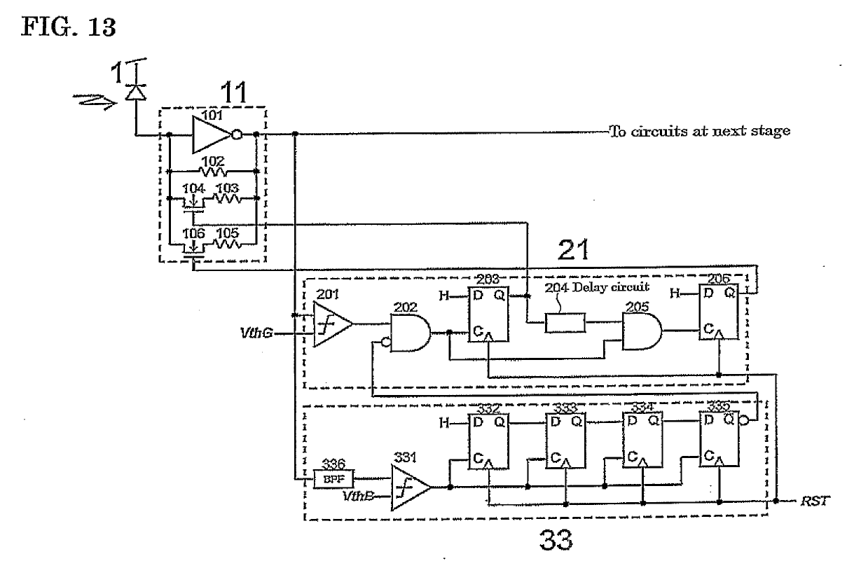

FIG. 13 shows the case where the burst signal detection circuit of the second embodiment shown in FIG. 6 is modified. The burst signal detection circuit 33 is one of the modifications.

As shown in FIG. 13, the burst signal detection circuit 33 includes a band-pass filter 336 connected to an output of the variable gain amplifier 11, a comparator 331 connected to an output from the band-pass filter 336, and a counter made up of latching circuits 332 to 335 connected to an output from the comparator 331 and an inverted output from the latching circuit 335 is used as an output from the burst signal detection circuit 33.

The configuration of the burst signal detection circuit 33 shown in FIG. 13 differs from that shown in FIG. 6 in that the band-pass filter 336 is connected to an input of the comparator 331. This causes a dc component to be removed at the time of inputting of the comparator 331 and, therefore, as shown in FIG. 9, a voltage of a pre-bias signal is equal to the burst signal detecting threshold voltage VthB, thus preventing the state where an input to the comparator 331 becomes unstable.

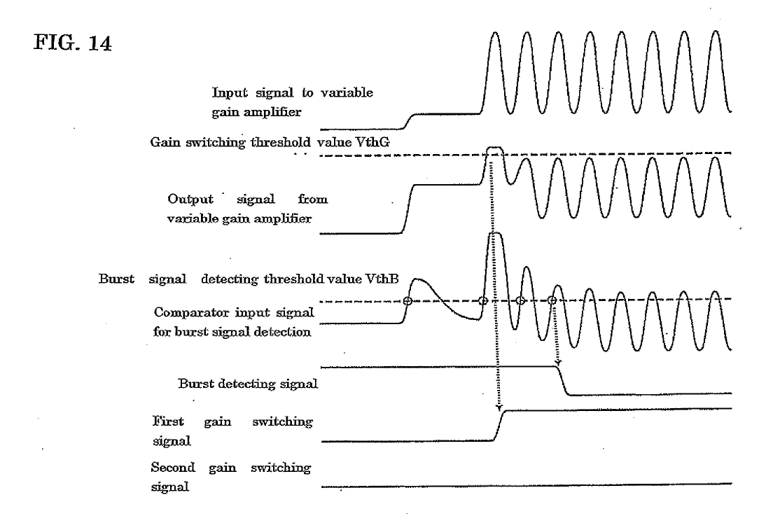

FIG. 14 shows the timing chart showing operations of the circuit shown in FIG. 13 under conditions including the inputting of the preamble signal.

By the band-pass filter 336 connected to the comparator 331, a signal from which dc components contained in an output signal from the variable gain amplifier 11 have been removed is inputted to the comparator 331.

In the comparator 331, an amplitude of the pre-bias signal exceeds the burst detecting threshold voltage VthB at the time of rising of the pre-bias signal and, therefore, an output from the latching circuit 332 becomes high. An input to the comparator 331 is a signal from which dc components have been removed, causing its voltage level to be gradually lowered and the amplitude of the pre-bias signal exceeds the burst detecting threshold voltage at its first bit, making an output from the latching circuit 333 be high.

Next, the rising of the second pulse causes an output of the latching circuit 334 to be high and the rising of the second pulse causes an output from the latching circuit 335 to become low, thus completing the operations of the burst signal detecting circuit 33 and, thereafter, the switching operations are disabled.

According to the circuit of the embodiment, even if the burst detecting circuit is activated by a pre-bias signal, a rising waveform can be reliably detected and, therefore, the operation is not easily influenced by noises superimposed on the pre-bias signal and by the pre-bias signal, thus enabling high-speed gain switching operations. Moreover, a high-pass filter can be used instead of the band-pass filter to provide the same effect.

### Embodiment 6

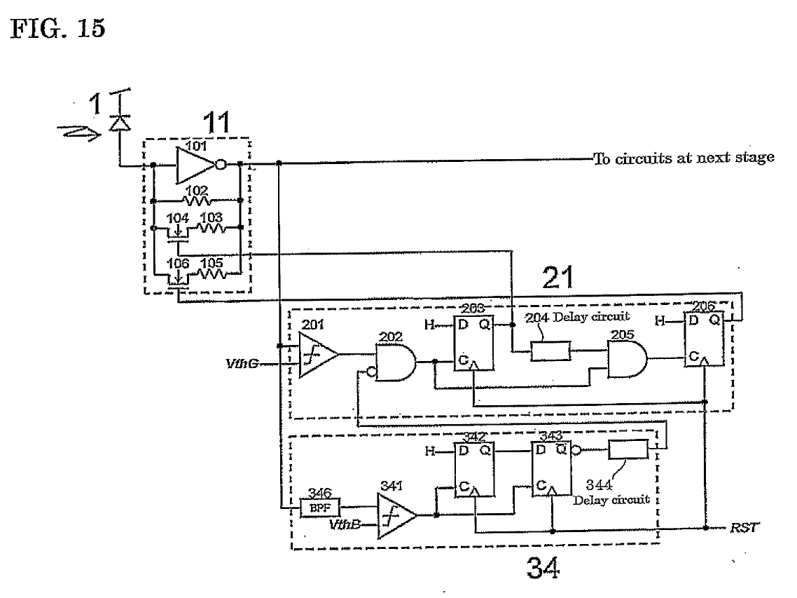

FIG. 15 shows the case where the burst signal detection circuit of the second embodiment shown in FIG. 6 is modified. The burst signal detection circuit 34 is one of the modifications.

As shown in FIG. 15, the burst signal detection circuit 34 includes a band-pass filter 346 connected to an output of the variable gain amplifier 11, a comparator 341 connected to an output from the band-pass filter 346, and a counter made up of the latching circuits 342 to 343, which are cascade-connected to each other, connected to an input from the comparator 341 and an inverted output from the latching circuit 343 is connected to a second delay circuit instead of the counter and an output from the delay circuit 344 is used as an output from the burst signal detection circuit 34.

The configuration of the burst signal detection circuit 34 shown in FIG. 15 differs from that shown in FIG. 13 in that two signal risings are detected by the latching circuit, that is, one being the rising of the pre-bias signal and another being the rising of a first bit of the preamble signal and, after the two-time detection of rising waveforms, the burst signal detecting signal is outputted after the lapse of a specified time in the delay circuit.

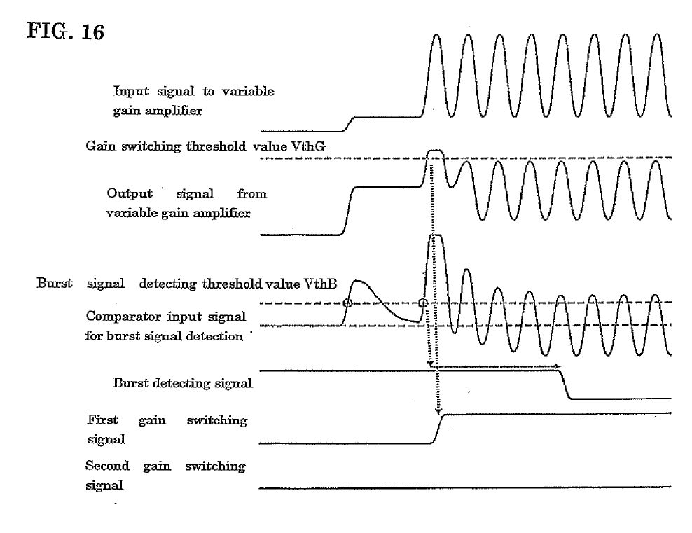

FIG. 16 shows the timing chart showing operations of the circuit shown in FIG. 15 under conditions including the inputting of the preamble signal.

The operations of the circuit of the sixth embodiment are the same as those from the timing of FIG. 14 showing the fifth embodiment to the detection of a signal of the first bit.

When an output from the latching circuit 343 becomes low, an output from the burst signal detecting circuit 34 becomes low with the time delay preset to the delay circuit 344 and then operations of the burst signal detecting circuit 33 are completed and, thereafter, the switching operations are disabled.

In the embodiments shown in FIGS. 15 and 13, an average value of the voltage of the input signal of the comparator having passed through the band-pass filter converges to a 0 (zero) level (same level appearing as at the time of no signal input) and, therefore, its peak value converges to a half of that of the dc-coupled circuit shown in FIG. 12 and backwards. As a result, with the lapse of time, the peak value is lowered and the probability that the amplitude of the signal exceeds the burst signal detecting threshold voltage VthB decreases. That is, it is difficult to adjust the detection timing by increasing the number of stages in the latching circuits. Accordingly, the use of the delay circuit employed in the embodiment is effective.

Thus, the circuit of the present invention is not easily influenced by noises superimposed on the pre-bias signal and by noises of the pre-bias signal and its length and can adjust the time required for the gain switching by using the delay time, thus achieving stable and high-speed gain switching operations.

The circuit of the present invention can be applied to an optical interface for access-type burst signal.

1. A burst-mode automatic gain control circuit operating as a burst-mode ready digital automatic gain control circuit comprising:
a variable gain amplifier; and
a burst signal detection circuit, wherein the variable gain amplifier is controlled based on results from detection by the burst signal detection circuit.

2. A burst-mode automatic gain control circuit operating as a burst-mode ready digital automatic gain control circuit comprising:
a variable gain amplifier to amplify an input signal and to output the signal;
a gain switching circuit to compare an amplitude of a signal outputted from the variable gain amplifier with a specified threshold and to control operations of the variable gain amplifier based on results from the comparison; and
a burst signal detection circuit to detect a specified signal identifying signal outputted from the variable gain amplifier and to control operations of the gain switching circuit based on results from the detection.

3. A burst-mode automatic gain control circuit operating as a burst-mode ready digital automatic control circuit comprising:
a variable gain amplifier to amplify an input signal and to output the signal;
a gain switching circuit to compare an amplitude of a signal outputted from the variable gain amplifier with a specified threshold and to control operations of the variable gain amplifier based on results from the comparison; and
a burst signal detection circuit to detect a specified signal identifying signal outputted from the variable gain amplifier by using a comparator to which a value being lower than the specified threshold is preset and to control operations of the gain switching circuit based on the detection.

4. The burst-mode automatic gain control circuit according to claim 3, wherein the specified signal identifying signal is a burst signal identifying signal.

5. The burst-mode automatic gain control circuit according to claim 4, wherein the gain switching circuit, when an amplitude of a signal outputted from the variable gain amplitude exceeds the specified threshold, switches a gain of the variable gain amplifier.

6. An access-type burst signal ready optical interface having the burst-mode automatic gain control circuit stated in claim 1.
